(19) United States
(12) Patent Application Publication
(10) Pub. No.: US 2020/0215751 A1
(43) Pub. Date: Jul. 9, 2020

(54) SHROUDS TO TRANSPORT ADDITIVE MANUFACTURING BUILD MATERIAL

(71) Applicant: HEWLETT-PACKARD DEVELOPMENT COMPANY, L.P., Spring, TX (US)

(72) Inventors: Arthur H. Barnes, Vancouver, WA (US); Joshua Hunsaker, Vancouver, WA (US)

(21) Appl. No.: 16/608,850

(22) PCT Filed: Sep. 26, 2017
(86) PCT No.: PCT/US2017/053494

§ 371 Date: Oct. 27, 2019

(51) Int. Cl. B29C 64/218; B29C 64/153; B29C 64/357; B33Y 30/00

(52) U.S. Cl. CPC B29C 64/218; B33Y 30/00; B29C 64/357; B29C 64/153

(57) ABSTRACT

Systems may reduce fugitive particles of powdered build materials in additive manufacturing by including a shroud positioned over a powder spreading roller, wherein the shroud forms a passageway to transport the fugitive particles. The bottom of the shroud forms a horizontally elongate opening to fit over an upper circumferential portion of the roller, leaving a lower circumferential portion extending out therefrom. The shroud may also be connected to a fan, blower, or other suction source to transport fugitive particles along a passageway, through a filter, and into a bin for collection or potential recycling. The system may include a brush or scraper positioned in the shroud and which contacts the spreading roller to help physically remove any fugitive particles that might be stuck to the roller.

### BACKGROUND

Certain additive manufacturing processes use powdered build materials that are spread in successive layers over a build chamber. For example, powdered build material may be spread using a roller from a deposit that is located at one side on the top of the build chamber to the opposite side of the build chamber. This spreading roller moves across the build chamber spreading the build material in a layer of desired thickness. Portions of each formed layer of build material may then be selectively solidified, using a variety of different techniques, to form a layer of a three-dimensional object. One example selective solidification technique selectively applies fusing agent and then applies fusing energy to thermally fuse the powdered material into a solid layer of the desired shape and size.

### BRIEF DESCRIPTION OF THE DRAWINGS

Various examples are described below referring to the following figures:

FIG. 1 is a side view cross section of an illustrative additive manufacturing system with a roller and fusing assembly in a first position, in accordance with various examples;

FIG. 2 is a side view cross section of the illustrative additive manufacturing system of FIG. 1 with the roller and fusing assembly in a second position, in accordance with various examples;

FIG. 3 is a close-up side view cross section of the illustrative additive manufacturing system of FIGS. 1 and 2, in accordance with various examples;

FIG. 4 is a side view cross section of an example apparatus for reducing fugitive powdered build material;

FIG. 5 is a bottom plan view of an example apparatus for reducing fugitive powdered build material; and

FIG. 6 is a side view cross section of an example apparatus for reducing fugitive powdered build material.

### DETAILED DESCRIPTION

In the aforementioned additive manufacturing processes, it is advantageous to operate the build process at high speeds in order to build the desired parts quickly and to mitigate temperature drops which can occur in the time period between the application of one layer of build material and the application of the next succeeding layer of build material. By way of example, in some systems, the temperature may drop 20 degrees C. between exposures from the overhead scanning thermic source during layer formation. As a result, additive manufacturing systems may apply successive layers of powdered build material at higher rate, e.g., one layer every four to eight seconds, which may require moving the spreading roller at a translational speed on the order of 50 centimeters per second.

Increasing the speed at which powdered build material is spread across the build chamber creates complications. For example, this increase in speed creates more powder contamination in the air as the rotational and translational speeds of the spreading roller increase. As the roller rotation speed increases, more particles may become entrained in the boundary layer near the periphery of the roller surface, which may generate a significant volume of fugitive dust particles of the build material. This dust tends to be comprised of the smallest and lightest of the particles in the particle size distribution of build material. These small particles are known as “fines,” which are particularly buoyant and disperse widely throughout the build environment. This airborne fugitive dust may thus become a contaminant inside the build environment.

The contamination due to airborne fugitive dust has many negative implications, such as degrading optical encoder systems which may lead to a decrease in accuracy, clogging of nozzles on a fusing agent dispenser, obscuring camera lenses and viewing windows, degrading bearings, and requiring additional cleaning.

Some additive manufacturing systems have used air handling systems positioned around the perimeter of the build area in an attempt to reduce fugitive particles of powdered build materials.

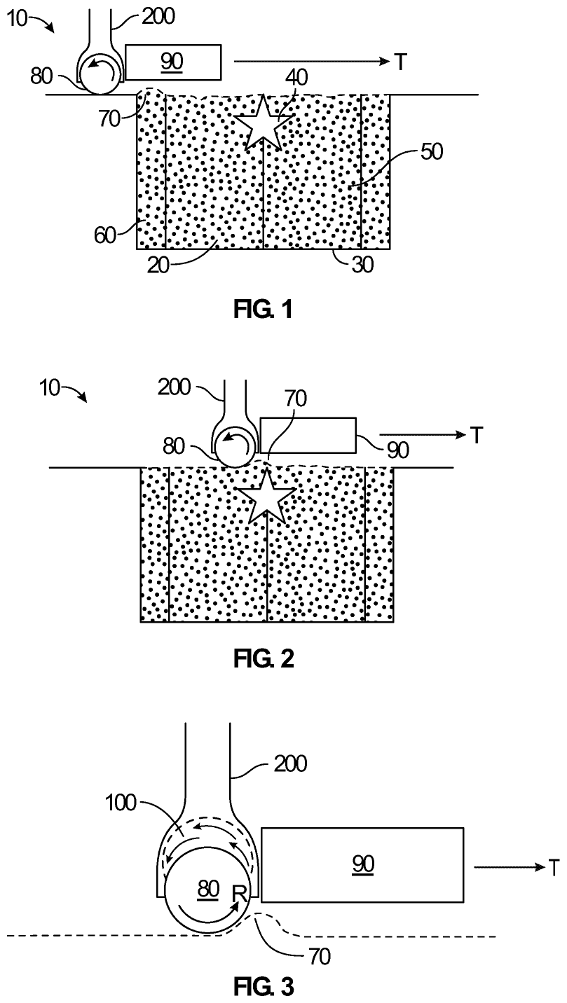

FIGS. 1-3 show an example of a portion of an additive manufacturing system 10. The system 10 is used for manufacturing a three-dimensional object, such as work piece 40. System 10 includes a build chamber 50 and a platen 30 which may move downward within the build chamber 50 as work piece 40 is gradually manufactured. Work piece 40 is manufactured by selectively fusing powdered build material 20 using a fusing assembly 90.

Work piece 40 is gradually manufactured by spreading multiple layers of powdered build material 20 using a spreading roller 80. Each layer of powdered build material 20 may be supplied from a powder supply dispenser 60 which deposits a powder supply pile 70 on one or both sides of the build chamber 50. The spreading roller 80 then moves on a moveable carriage (not shown) across the build chamber 50, spreading the powder 20 in an even layer across the build chamber 50. By way of example, spreading roller 80 may spread powdered build material 20 from pile 70, moving from the left to the right as shown by arrow T in FIGS. 1-3. Fusing materials and/or fusing energy may then be applied using the fusing assembly 90 at desired locations on the surface of the layer of powdered build material 20. Each fused layer of build material 20 becomes a layer of the work piece 40.

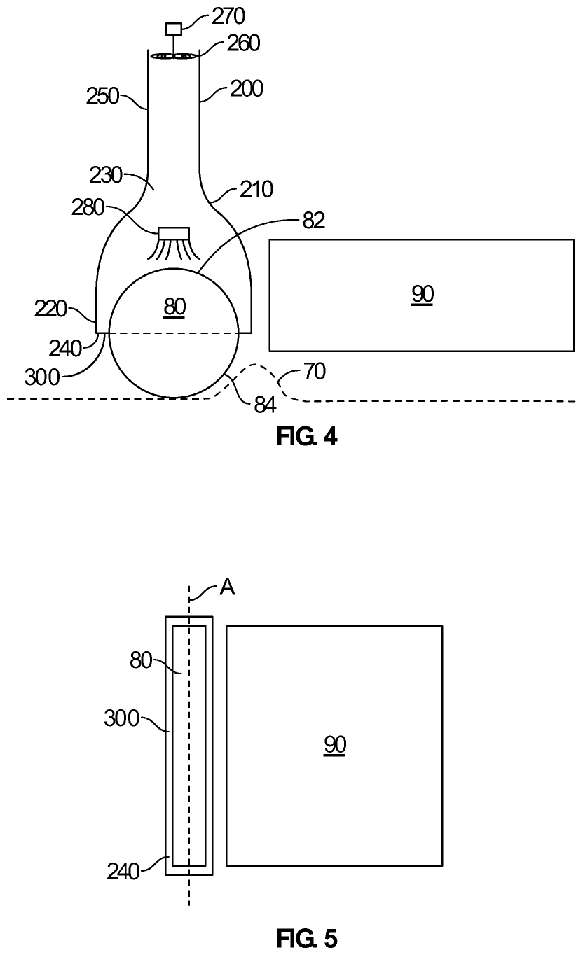

As illustrated in FIG. 3, when the powder spreading roller 80 rotates and translates across the build chamber 50, small particles of powdered build material 20 may cling to the surface of the build material spreading roller 80. As the spreading roller 80 translates and rotates at higher speeds, as indicated by arrow R, particles of build material 20 may be flung off the surface of the roller 80 and create a plume 100 of fugitive particles of powdered build material 20. If left unprotected, the plume 100 may then further disperse with translational movement of the powder spreading roller 80 so as to deposit build material 20 in undesired locations, thus creating potential contamination and interference with components of the additive manufacturing system. A shroud 200 as depicted in FIGS. 1-3 collects and evacuates the excess build material, as is now described in greater detail with respect to FIGS. 4-6.

FIGS. 4-6 provide detailed examples of various systems useful for reducing potential contamination from powdered build material 20 that are used in additive manufacturing processes (FIGS. 1-3). A shroud 200 is located over the powder spreading roller 80. The shroud 200 is configured to remove fugitive particles of powdered build material 20 that may become stuck to or are flung from the moving roller 80.

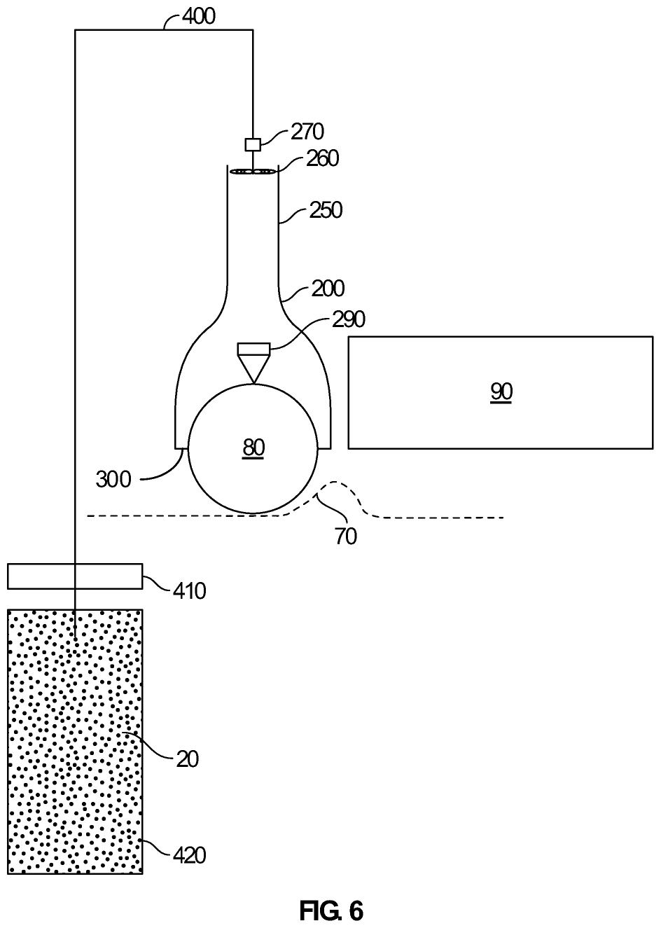

Powder spreading roller 80 has a generally cylindrical shape. Roller 80 has a longitudinal axis of rotation, indicated by line A in FIG. 5. Roller 80 is positioned within the system 10 to spread a pile 70 of powdered build material 20 in an even layer across the build chamber 50. Roller 80 may move in front of or behind fusing assembly 90 which supplies fusing material and/or energy to the layer of powdered build material 20 in order to form work piece 40.

As shown in FIGS. 4 and 5, the shroud 200 fits over an upper circumferential portion 82 of powder spreading roller 80. Shroud 200 may include a bottom end 220 that forms a generally horizontally elongate opening 240 which fits closely around the exterior surface of the horizontal axial length of the powder spreading roller 80. For example, the horizontally elongate opening 240 may form a gap 300 of about 1-5 mm between the opening 240 on the bottom end 220 of shroud 200 and the exterior of roller 80.

The lower circumferential portion 84 of powder spreading roller 80 extends out from beneath the shroud 200 in order to spread the powdered build material 20. The lower circumferential portion 84 of the roller 80, which extends out from beneath the shroud 200, may have a height equal to or slightly higher than the expected height of pile 70 of powdered build material 20. In this manner, shroud 200 may surround the upper circumferential portion 82 of roller 80 in order to trap fugitive particles of powdered build material 20, while also not interfering with spreading of the powdered build material 20 by the lower circumferential portion 84 of roller 80. By way of example, with a roller 80 having a diameter of 40 mm, a lower circumferential portion 84 may extend out from beneath opening 240 by about 10-15 mm. The diameter of roller 80 and the expected height of pile 70 may vary significantly between different additive manufacturing systems 10, such that the height of the upper circumferential portion 82 and lower circumferential portion 84 may also vary significantly.

The shroud 200 includes a body portion 210 located above the horizontally elongate opening 240. The body portion 210 may be formed of a rigid material such as plastic or metal. Shroud body portion 210 forms a hollow chamber 230 which extends above and around the upper circumferential portion 82 of the powder spreading roller 80. To assist in evacuating fugitive particles of powdered build material 20, the chamber 230 may also be connected to a passage 250 to assist in removing fugitive particles to a location outside the vicinity of the spreading roller 80, and eventually outside the build chamber 50. Shroud 200 may also include or be connected to a fan 260 connected to a motor 270, which functions to draw air with any entrained particles of fugitive build material 20 out from the shroud body portion 210 and into the passage 250. Numerous other such vacuum sources may be used to help evacuate fugitive particles of powdered build materials, including vacuum pumps, blowers, and turbines, as well as other air handling equipment which may be present within other areas of the system 10.

The interior of the shroud chamber 230 may also include a brush 280 or a scraper 290 (FIG. 6), which extend generally along the axis of the spreading roller 80 to facilitate removing fugitive particles of powdered build material 20 from the exterior of roller 80. As spreading roller 80 rotates during operation, if any particles of material 20 are not flung off the rotating roller 80 and into the chamber 230, these remaining particles may be brushed or scraped off the exterior of roller 80 as the exterior surface passes under brush 280 or scraper 290.

As shown in FIG. 6, the shroud 200 may be connected to a conduit 400 in order to transport the fugitive particles build material 20 away from the build area or other sensitive equipment in the vicinity of the build area. A portion of conduit 400 or passageway 250 may also comprise a flexible portion, for example, a flexible hose, to allow movement of the powder spreading roller 80 during normal operation of the system 10. Fugitive particles of powder 20 are evacuated from shroud chamber 230, drawn into the passageway 250, and removed through conduit 400 so as to avoid contamination of or interference with equipment within the build chamber 50 within the system 10.

As indicated in FIGS. 1 and 2, a certain amount of excess powdered build material 20 will typically remain unfused after the system 10 finishes manufacturing a work piece 40 in build chamber 50. During normal operation, this excess powdered build material 20 may be collected by air handling equipment positioned around the build chamber 50. This excess of powdered build material 20 may also be collected and recycled, or mixed with fresh powder 20, for use in manufacturing another work piece 40 of desired shape and size.

As shown in FIG. 6, fugitive particles of build material 20 that flow through passageway 250 and conduit 400 may be collected downstream in a powder recycling bin 420. Bin 420 may be a dedicated bin that is used for fugitive particles collected through the passageway 250 and conduit 400. Bin 420 may also be shared with other system components which collect other forms of excess powdered build material 20 and recycled during the present or future build.

To facilitate recycling and environmental protection, a filter 410 may be positioned upstream of recycling bin 420 to filter fugitive particles of build material 20 before they enter recycling bin 420. Filter 410 may be selected to remove potential airborne contaminants. For example, filter 410 may be selected to filter larger sized particles of build material 20 which may not be suitable for recycling. Bin 420 and filter 410 can also be used as the primary or principal collection system if recycling is undesirable or disabled for a particular session.

In this manner, fugitive particles of build material 20 that are either flung off the spreading roller 80 or are scraped or brushed off the spreading roller 80 are first collected within the shroud chamber 230. These fugitive particles collected in chamber 230 then flow through passage 250, through conduit 400, pass through filter 410, and into recycling bin 420.

Examples of the disclosed apparatus may assist in reducing fugitive particles of powered build material 20, which allows increasing the moving speed of the spreading roller 80, thereby potentially reducing the manufacturing time and reducing harmful temperature drops between the application of successive layers of the build material 20, all while reducing fugitive particles that might otherwise cause contamination in the build area or other degradation of performance.

The above discussion is meant to be illustrative of the principles and various examples of the present disclosure. Numerous variations and modifications to these examples are contemplated. It is intended that the following claims be interpreted to embrace all such variations and modifications.

What is claimed is:

1. An apparatus comprising:
a powder spreading roller usable in an additive manufacturing process; and
a shroud positioned over the powder spreading roller, the shroud having a body portion and a bottom end,
wherein the bottom end of the shroud forms a horizontally elongate opening to fit over an upper circumferential portion of the roller along a horizontal axial length of the roller,
wherein a lower circumferential portion of the roller extends out from below the opening in the shroud, and
wherein the body portion extends upward from the opening and forms a passage to transport powdered build material exiting the upper circumferential portion of the roller.

2. The apparatus of claim 1 further including a vacuum source connected to the passage in the body portion of the shroud to generate air flow out of the body portion.

3. The apparatus of claim 2 wherein the vacuum source is a fan.

4. The apparatus of claim 1 further including a brush positioned within the body portion of the shroud and in contact with the roller.

5. The apparatus of claim 1 further including a scraper positioned within the body portion of the shroud and in contact with the roller.

6. The apparatus of claim 1 further including a filter positioned in fluid communication with the passage in the body portion of the shroud.

7. The apparatus of claim 2 further including a filter positioned in fluid communication with the passage in the body portion of the shroud.

8. The apparatus of claim 1 wherein the passage in the body portion of the shroud is in fluid communication with a receptacle for storing recyclable powdered build material.

9. The apparatus of claim 2 wherein the passage in the body portion of the shroud is in fluid communication with a receptacle for storing recyclable powdered build material.

10. An apparatus comprising:
a powder spreading roller usable in an additive manufacturing process; and
a shroud positioned over the powder spreading roller, the shroud having a rigid body portion and a bottom end,
wherein the bottom end of the shroud forms a horizontally elongate opening to fit over an upper circumferential portion of the roller such that the shroud surrounds an axial length of the roller;
wherein a lower circumferential portion of the roller extends out from below the opening in the shroud, and
wherein the body portion extends upward from the opening to form a chamber above the roller and a passage extending beyond the chamber; and
a vacuum source connected to the passage in the body portion of the shroud to generate air flow out of the chamber above the roller and to transport powdered build material exiting the upper circumferential portion of the roller.

11. The apparatus of claim 10 wherein the vacuum source is a fan.

12. The apparatus of claim 10 further including a brush positioned within the chamber of the shroud and in contact with the roller.

13. The apparatus of claim 10 further including a scraper positioned within the body portion of the shroud and in contact with the roller.

14. The apparatus of claim 10 further including a filter positioned in fluid communication with the passage in the body portion of the shroud.

15. The apparatus of claim 10 wherein the passage in the body portion of the shroud is in fluid communication with a receptacle for storing recyclable powdered build material.
